(19) United States
(12) Patent Application Publication
(10) Pub. No.: US 2026/0289593 A1
(43) Pub. Date: Sep. 24, 2026

(54) Systems and Methods for Fan Evaluation and Community Development

(71) Applicant: FandomIQ, San Diego, CA (US)

(72) Inventors: Philip Mordecai, St. Albans (GB); Gary B. Fogel, San Diego, CA (US)

(21) Appl. No.: 19/575,663

(22) Filed: Mar. 23, 2026

Related U.S. Application Data
(63) Continuation-in-part of application No. 18/972,495, filed on Dec. 6, 2024.
(60) Provisional application No. 63/632,345, filed on Apr. 10, 2024.
(60) Provisional application No. 63/679,496, filed on Aug. 5, 2024.

(51) Int. Cl. G06Q 30/0201

(52) U.S. Cl. CPC G06Q 30/02012

(57) ABSTRACT

Novel systems and methods to determine a person's status as a fan of a product and/or service through machine learning for the purpose of customer management, community management, product development, directed marketing, and branded content entertainment in a dynamic, real-time, and optimized manner. These novel systems and methods also for optimizing the delivery of marketing and non-marketing content to fans making use of an ecosystem, such as an embargo hub, for the analysis and understanding of fan behavior in terms of fan-content interaction, fan-community interaction, and their combination.

### RELATED APPLICATIONS

This application is a continuation-in-part application which claims priority from U.S. patent application Ser. No. 18/972,496 filed Dec. 6, 2024, which claims the benefit of priority from U.S. Provisional Application No. 63/632,345 filed Apr. 10, 2024, and U.S. Provisional Application No. 63/679,496 filed Aug. 5, 2024, the contents of which are hereby incorporated by reference herein.

### FIELD OF THE INVENTION

The present invention provides novel systems and methods to determine a person's status as a fan of a product and/or service through machine learning for the purpose of customer management, community management, product development, directed marketing, and branded content entertainment in a dynamic, real-time, and optimized manner. These novel systems and methods also allow for the determination of the monetary value of marketing content and fan communities for advertising relative to the behaviors of individual fans or fan communities. While the history of marketing offers many techniques to help target content to specific users, these approaches generally lack an understanding of what it means to be a “fan” of the brand, product, service, entity, culture, ideology, political affiliation, or any combination thereof that is being marketed. Further, such approaches have difficulty identifying and targeting fans and then enlisting their rapid assistance in evaluating novel content through a secured system prior to larger content release to a broader audience. The present invention makes use of such a marketing ecosystem including a secure platform known as an “embargo hub” combined with known fan communities to showcase marketing content, evaluate and adjust said content dynamically, simultaneously developing a better model of what it means to be a “fan” in various contexts or environments, how then to identify new likely fans and their associated communities, and how to generate new content that will be of greatest interest to those fans and associated communities or their combination. By understanding fans, their associated communities, their associated environments, and adjacent fandoms via the ecosystem, the systems and methods described here measure fanness, improve production and the delivery of content to fans in a precise way, improve the understanding of the behaviors and dynamics of individual fans to fan communities, improve the understanding and relatedness of fan communities, improve the understanding of content's media value, improve the content being produced and likelihood of fan engagement, thereby enhancing overall marketing effectiveness and measured outcomes such as targeting, return on investment, sales, and revenue.

### BACKGROUND OF THE INVENTION

A portion of our systems and methods focus on an improved understanding of what it means to be a “fan,” qualification for being a fan, characteristics of fan “communities,” and how to measure fan communities and “fandom” quantitatively, qualitatively, or both quantitatively and qualitatively through the delivery of content in a specific manner to assess resulting behavioral changes across individual fans and within fan communities. For instance, quantitative measures such as the number, frequency, and type of interactions with specific content can be used as well as qualitative measures such as personal opinion. This includes examining relationships of fans to marketing content, similarities or commonalities between fans, following the deployment of content and subsequent fan interactions within a specifically designed ecosystem for the improved understanding of such relationships, their environments, and interactions. The formation of a fan community is not determined solely by a specific number of fans but rather by the duration, dynamics, the fan environment, quality, and quantity of interaction, engagement among them in their fan communities, and adjacent fan communities, and their collective and individual behaviors, emotions, and psychology.

Key attributes in measuring fandom include the connections and behaviors of fans. Fandom is a community of fans who share a common interest, and it serves as a social space where fans interact and celebrate their passions. Fandom is defined by community engagement, including gatherings and discussions, and it often develops its own unique culture and shared values. A fan community encompasses more than just shared interests from two or more fans; it involves social connections, interactions, participation, shared interests, cultural values, common goals, competition, social status, a general sense of loyalty, a fear of missing out on latest trends, forms of symbiosis, an emotional sense of belonging, or some or all of the above. Such fan communities are essential for product loyalty, customization, and advocacy emanating from a trust network. Consequently, sub-groups of fans may emerge within the larger fan community as they interact and connect over common interests. Such fan sub-groups or fan communities can also serve as a source of information for improved marketing decisions no matter if the fan reaction is positive, neutral, or negative. Conversely, as an example, individuals who appreciate a product or brand or product and brand, but do not engage with others around the product and/or brand, would not be considered as an active part of the product fan community. In the case of a monopoly, consumers have little choice in the matter of the product they buy and while considered as “loyal” customers, they may not truly be part of a product fan community. In the case of a product that is chemically addictive, addicted consumers may have less inherent choice about their status as a fan as they may purchase a product simply to satisfy the addition. The ecosystem described by our systems and methods allows for the determination of actual fan status despite these concerns and does not rely solely on self-attestation, purchase attribution or social media attributions or the combination of purchase attribution and social media attribution. Additionally, it is not always the case that fans become a community out of interest for example a product and/or a brand, an interest or an organization such as a team or group, but rather they can be a fan of a community that is counter-culture, toxic or anti-establishment, and in this case their “fandom” is in shared opposition to a product. As such fandom can be said to exist on a spectrum from −1 (definitely not a fan) to 0 (ambivalence) to +1 (definitely a fan) where for any fan this value can change with time. In our approach, these varying measurements are factored into fandom metrics and are used to assist in the optimization of content production and delivery to consumers of that content in a tiered or continuous, relative to their level of fandom, fanness, and community involvement, approach that uses known fans to help evaluate content before, or concurrently with, its wider distribution to a broader audience, to help enable dynamic adjustment of the content, assessment of the fan-value the content together with any potential advertising around the fan-content and to aid identification of new or likely fans of that content from a broader pool of potential fans. Such systems and methods could be used to monitor or improve overall fan community, fan engagement, customer retention, loyalty, calculate the environmental impact of marketing to a fan and fan community or both fans and fan communities within each marketing channel, and brand engagement beyond traditional customer sales.

Marketing channels rely on transitional production workflows with a human director selecting and assembling content typically from limited, fixed camera sources, to create a single unified program output where this output is provided to a large community at one time. Such systems attempt to generate fans from content that is believed to be useful on the average across a large population of possible fans. Such systems do not support the opportunity for production decisions that are tailored to subcommunities or individual fans nor do they ingest heterogeneous content from user-generated content devices, ground-based cameras, aerial cameras, space-based cameras, sensors, or large-scale surveillance and defense networks. Existing personalization technologies operate only at a recommendation layer and do not personalize production-level logic. Similarly, current scoring methods lack evaluation of video content on a frame-by-frame basis relative to fan data, community data, mission-specific data, environmental metadata, or many other types of data that could be used to determine which content should go to which individual in real time. Furthermore, conventional systems and methods do not implement sensor-fusion logic capable of combining the multi-modal data types together with mission goals and with audiovisual sources for real-time editorial decision-making. Our system and method describes autonomous ingestion and fusion of multi-source audiovisual and environmental data, dynamically scoring content on time frames shorter than the original full length of the content, even on a frame-by-frame basis, with virtual directors delivering individualized content across encrypted or non-encrypted networks and doing so autonomously, semi-autonomously, or providing such content to human decision makers in charge of production.

Previous approaches focus largely on transactional information for such measures. For instance, U.S. Pat. No. 9,165,270 discloses methods to predict the likelihood of customer retention or attrition. While useful, this approach makes use of transactional data and store location rather than the presentation of marketing material to such customers to determine their likelihood of liking or disliking the content. Many possible systems and methods can be devised to distribute and provide access to content to fans through marketing platforms. For instance, US Patent Pub. No. 2006/0085255, highlights the importance of brand equity as a crucial measure of marketing effectiveness. It uses historical data to develop brand equity metrics to aid in continuous improvement within organizations through the access to custom analytics dashboard. The invention differs from our approach significantly because it fails to provide capabilities or metrics for real-time data or fan feedback or the combination of real-time data and fan feedback of content within a marketing ecosystem that includes an embargo hub. The invention includes an ecosystem such as an embargo hub that operates as a secure, access-controlled, scalable, real-time testing environment for content, representing a modern digital evolution of traditional focus-group testing. Unlike conventional focus groups, the embargo hub is not limited by physical location, group size, or cognitive capacity of human moderators, and supports continuous testing at scale within virtual worlds, online environments, or hybrid digital and analog contexts. To capture hybrid environment interaction data, the embargo hub enables closed or restricted content exposure directly to targeted communities, cohorts, or individuals, with or without the explicit knowledge of participating end users. Data generated within the embargo hub forms a persistent knowledge base that is used to train, update, and refine fan models, which in turn drive automated content scoring, matching, and one-to-one personalized content production through one or more AI-based virtual directors or hybrid human-AI director teams. Our systems and methods provide content to known fans through a marketing ecosystem. One such ecosystem, including a secured digital “embargo hub,” can be used to develop and launch products, engage with fan communities to showcase and build lasting brand discoverability and relationships, including custom fan-first content experiences in one secured or unsecured, encrypted or unencrypted destination using the blockchain, where real-time data can be collected about fan behaviors relative to content, using artificial intelligence or machine learning or statistical assessment or their combination to help understand fans, their behavior, metrics of fandom, brand growth in fan communities, and to provide content to fans in optimized and useful ways. Analog modules of the embargo hub include in-person focus groups, physical events, physical secured content and delivery, and their combination, and these can be also held on their own or in combination with a digital embargo hub. Within this embargo hub, fans are able to interact with content in discrete or continuous ways with their interactions recorded in real-time. These interactions then aid the generation of new content generation and help in the evaluation of fan behavior such that new fans can be identified. The embargo hub can also provide real-time feedback to assist in product development, focus group testing, and the understanding of fandoms, to help with valuable raw data in new product development areas.

The general concept of providing content to consumers is itself the very basis of marketing and community engagement. As a result, there are many patents associated with the providing of content to individuals through various devices and approaches, however none make use of an embargo hub and a secure, decentralized distributed ledger systems, such as a blockchain, in the novel manner that we describe. Further our approach can be extended to either open or closed networks on the cloud as desired. The closed network systems and blockchain facilitates the encrypted safe storage and sharing of content across a network of users, while also functioning as a decentralized ledger system for data collection, storage, and access. The distribution layer performs dynamic channel selection, encryption management, latency adaptation, and device-specific encoding optimization, aligning mission timelines, network performance, or coordinated fan experiences. For instance, U.S. Pat. No. 10,345,897 disclosed methods for spectators to provide inputs to games through an application programming interface such that spectators may influence the game or become themselves involved with the game, typically through streaming services. While this approach mimics a type of embargo hub and allows for the collection of data about the spectators and their interaction with the game, it fails to utilize such data for improved marketing purposes or to determine fandom metrics beyond game environments. Similarly, U.S. Pat. No. 10,390,0064 offers a spectating system to allow participants to interact with a game, receive rewards, and offer comments on content, the focus of the system and method is on the value exchange of watching the content and not on how to gather information about such interaction for the adjustment of marketing content and timing or to specifically evaluate participants for their level of fandom.

U.S. Pat. No. U.S. 9,680,915 focuses on the identification of “influencers” through clustering networks. While the method offers flexibility in tuning data clusters and analyzing network topologies, its core methodology is predominantly focused on traditional network clustering metrics, such as centrality and link distance, to determine influential nodes as influencers. This system is insufficient for capturing the complexity of fandom, such as psychological and behavioral dimensions, and unlike our systems and methods which are focused on identifying fans and measuring levels of fandom, we account for emotional intensity, frequency of interaction, and the specific cultural markers that define fan behavior. U.S. Pat. No. 11,052,321 also focuses on the gathering of information about participants in game environments but is specific to instream participation metrics and rewards without any connection to social media data or fandom. U.S. Pat. No. 11,488,189 focuses on the identification of location data on a mobile device associated with sales promotions in a virtual game environment. While useful for scoring user interest and providing rewards, our system and method does not rely on mobile device location, or rewards in virtual games and focuses instead on the behavior of individuals as fans in an ecosystem such as an embargo hub to extract information about fandom, marketing content, and fan engagement irrespective of where they are located physically at the time of their interaction with said content.

U.S. Pat. No. 10,345,897 focuses on optimizing the effectiveness of communicating marketing content within platforms or digital media while simultaneously conducting cause-and-effect experiments and using machine learning. The purpose of the invention is to assess how content is optimized through experiments and machine learning algorithms to enhance effectiveness metrics. While in part this approach mimics the marketing optimization outcome method described in our systems and methods, it fundamentally precludes privacy-focused data optimization and/or the use of decentralized networks. The systems and methods of our invention specifically permit the use blockchain-based platforms such as an embargo hub and therefore allow for the targeting the collection and feedback of data without the need of centralized user data. Additionally, our systems and methods include data and information obtained both within an ecosystem similar to an embargo hub and outside of such an ecosystem, and our approach includes methods to permit the exchange of information from the fan ecosystem to and from third parties via a data gateway and application programming interface (API).

U.S. Pat. No. U.S. 11,392,969 centers on a system for profiling and predicting customer behavior using various data sources and advanced machine learning techniques. Its goal is to enhance sales, marketing, and customer analytics. This invention is a smart computer system designed to utilize historical data to help businesses anticipate their customer's future actions, enabling more effective targeting by accurately understanding their preferences and behaviors. Unlike our decentralized compatible ecosystem approach, this method does not consider fans or real-time data processing or analysis of marketing feedback. While approaches such as this make use of uni-directional data gateways to connect with third parties, through our systems and methods this data gateway can be either uni-directional or bi-directional and include data solutions provided by the product or brand being marketed.

Key attributes in the calculation of “fandom” are the level of “fanness.” Fanness refers to the experience and dynamics of being a fan, marked by enthusiasm and dedication to a specific subject. It involves feelings and knowledge about the subject, reflecting a level of interest and emotional investment commitment, and also a level passion connection, the degree of knowledge, and possible visible indications of community membership. The embargo hub can be used to study concepts of fanness including the relation of the speed that someone becomes a fan to the longevity of that fan, or stages of fanness, from initial infatuation to disillusionment. The embargo hub ecosystem can be used to determine where a fan exists on a spectrum of “fandom” and a level of “fanness” from being fully committed to a brand and/or fan community to being fully committed in opposition to a brand and/or fan community. An “uncommitted fan” has no community commitment whatsoever and sits at the middle of these two extremes. The dynamics of fan behavior can also be described. For instance, there are “fringe fans” or “casual fans” or “fairweather fans” who change their commitment to a brand or community regularly as opposed to “super fans” or “pro fans” who retain loyalty to a brand or community no matter the circumstances. A fan community consists of two or more fans who share common interests, values, or goals, often engaging in regular interactions. Conversely, a fandom is a specialized type of community centered around a specific interest, characterized by heightened enthusiasm, communication, engagement and often active advocacy which can result in the creation and sharing of related content. Within the embargo hub, each fan's level of fandom is dynamic relative to a given brand and external forces. The embargo hub offers a unique opportunity to study fandom, its dynamics, to produce and evaluate content in real-time relative to fan behavior, and to build brand fandom through the distribution and matching of content to fans, fan clusters, fan communities, or fandoms, within or external to the embargo hub deemed valued by brand fans from within the embargo hub.

U.S. Pat. No. U.S. 8,620,718 outlines a computer-implemented brand benchmarking system that utilizes social media metrics, such as fan page counts, to compare brands within the same industry and geographical area. The system evaluates brands based on specific metrics derived from social media interactions to develop audience and engagement scores for brand benchmarking. However, unlike our systems and methods, it is not specifically designed to optimize marketing content in real-time. While brand fan benchmarking is one potential outcome of our invention, U.S. Pat. No. 8,620,718 B2 focuses on the quantification and monitoring of social media network data to compute benchmark analyses and scores. In comparison, the ecosystem defined by our systems and methods offer a broader scope by incorporating real-time data feedback, plus offline and analogue data sources. Within the embargo hub fans can also be clustered into similar groups to determine demographic or other qualities that help drive fan behavior.

U.S. Pat. No. 10,362,072 provides an example of systems and methods for team conferencing using a real-time conference engine and virtual rooms to allow people to collaboratively experience libraries of rich media content in personalized rooms, fan pages, or websites. While this is a useful example of how content can be distributed to groups of individuals to help understand their behavior, there is no direct connection to a system with restricted access to that content based on fan qualification, nor is there a system that adjusts the identification of new fans and generation of new content in dynamic fashion relative to the behavior of fans within an embargo hub-like setting such as is offered in our systems and methods. U.S. Pat. No. 9,820,002 shares these same issues in that it provides a system and methods for the review of digital multimedia but has no mention of fans, fandom, or the recommendation of specific content to specific fans based on fan score matching, based on the data being collected by this multimedia presentation. U.S. Pat. No. 10,339,541 focuses on the delivery of application media content to multiple social media systems for display to members of said social media systems. While the approach delivers content to specific groups of users, the system and method described in U.S. Pat. No. 10,399,541 makes no reference to fandom or fans, or the matching of content to generate a measure of the quality of fans, fan affinity, or inferred fan quality, or to the adjustment of the media content based on the quality of those fans or such measures. In contrast, the present invention provides for content-to-fan matching based on fan metrics and inferred fan attributes and may further include optimization of such matching or content adjustment in certain embodiments.

U.S. Pat. No. 8,954,449 discloses a method for identifying a brand influencer by scanning social media objects published by at least one social networking entity to identify the first social media object posted by a first user and relating that to a brand associated with a product, an enterprise, a service, a person, a concept, and/or a trackable object. While influencers on occasion could be considered as a type of fan, the approach requires a multi-tenanted customer relationship management database for the analysis and scoring of brand influence of users only on a social media network. The approach does not make use of a private, secured, blockchain embargo hub ecosystem, nor does it seek to identify and score fans in general, simply influencers within social media networks. And while U.S. Pat. No. 8,954,449 makes use of a calculated “brand influence score,” their approach makes use of fans specifically to identify key influencers in social media, is focused on social media data collection and analysis, and comparison of the brand influence score to a predefined threshold. Our systems and methods are not predicated on the use of a predefined threshold, nor are they focused on finding key influencers in social media, rather we use an embargo hub to offer content to a fan community, measure qualitative and quantitative response from all fans in that community and consider them all as possible influencers, with valued insight about marketing content.

Our systems and methods for fandom metrics and content engagement are non-invasive and do not require specific devices to be applied to individuals for their measurement relative to marketing content. U.S. Pat. No. 8,688,541 focuses on online auction systems and utilizes the bidding history of users in the auctions to determine which users will be promoted to additional online auctions based on their bidding history. The invention is specific to bid and auction outcomes and adds users to a list for future marketing based on their bidding history rather than dynamic real-time marketing based on real-time actions to marketing content in an embargo hub where the content does not have to be specific to online auctions. U.S. Pat. No. 8,473,044 describes a system and method for the measure and ranking of response to an audiovisual or interactive media through the use of alpha asymmetry of the individual's brain via a specialized headset to capture brain signals. Our approach avoids the need for such headsets or other worn devices. While the embargo hub could include web-based content, our systems and methods do not require the tracking of individuals to specific websites on the internet. For instance, U.S. Pat. No. 8,417,557 evaluates the engagement of webpage visitors on a web server and uses this to associate a profile with each visitor. While this is a useful example of associating metrics or scores in a dynamic way relative to user behavior, their invention is specific to website data tracking and the tracking of visitors to websites over time. Our systems and methods provide marketing information and data to a group of predetermined cohort of fans who are each assigned unique user profiles through a secure embargo hub. This cohort represents all aspects of the fanness spectrum including those who are ambivalent about a product or service so as to act as a control group for marketing evaluation. The embargo hub is flexible to the many ways that fan users can interact with marketing content. Quantitative and qualitative measures are then associated with a fan user profile and are not solely reliant on how often a user visits a website over time to score their degree of fandom.

U.S. Pat. No. 12,073,421 generates recommendations for content creators operating in a subscription or membership context to assist with targeting. By contrast, our present invention does not require generating subscription recommendations for creators, nor does it depend on a creator “membership platform” construct or subscription-tier management as the core technical mechanism. Accordingly, even where the present invention may operate in environments that include users or accounts, our invention does not perform platform-level subscription recommendation outputs for creators.

U.S. Pat. No. 12,245,111 generally relates to the recognition of subscribers in an augmented-reality view. The present invention is not limited to, and does not require, augmented reality rendering, overlays, or identity workflows to function. Where our invention uses identifiers, it does so without augmented-reality display constraints, device capture/pose mapping, or subscriber overlay requirements.

US Patent 2024/0095771A1 focuses on generating an account-management user interface that conveys subscriber behavior, including indicators like likelihood of continued subscribership/engagement, often using behavior attributes, weighting, and potentially updates within a membership platform using machine learning. The present invention differs because it does not require determining or displaying subscriber likelihood/churn-style behavior attributes in a membership-platform account user interface, nor does it require the particular subscription-status signals and time-interval behavior scoring described. The present invention does not include the combination of membership-platform subscribership information, behavior attribute values representing likelihood of continued subscribership over intervals, and a creator account user interface specifically configured around those likelihood visualizations.

US Patent 2024/0362631A1 describes dynamic distribution of content pages or user-interface content during transaction flows, including validation that content will render for a tagged user-interface element based on device software/hardware configuration, and may include a “fit score” or validation output. The present invention does not depend on transaction-stage page flows, tagged user-interface element content validation, or device-configuration scoring as a prerequisite to delivering its functionality. In particular, the present invention does not require calculating content fit scores for user-interface element placement or validating content for transaction flows in the manner claimed.

U.S. Pat. No. 10,510,051 introduces artificial intelligence into an electronic meeting context to perform tasks such as agenda creation, participant selection, and other intra-meeting assistance functions. The present invention is not directed to artificial intelligence-assisted meeting management, nor does it require the creation, modification, or control of meeting artifacts as its core system and method. Any use of artificial intelligence in the present invention occurs outside the claimed electronic meeting processing framework and does not require intra-meeting monitoring or management steps.

U.S. Pat. No. 10,827,220 focuses on client-side playback where personalized media is generated dynamically for event opportunities embedded within programming content implying advertisement-like insertion opportunities, timing windows, or triggers. The present invention differs by not requiring client-side generation of personalized media assets specifically tied to “event opportunities” in a programming stream, nor requiring the associated insertion/playback constraints that define the reference's architecture. Where the present invention may present or sequence content, it does not do so by dynamically generating personalized media for programming-stream event opportunities at the client in the manner claimed. Therefore, the present invention does not practice those event-opportunity dynamic personalization limitations.

U.S. Pat. No. 11,538,213 concerns creating or distributing interactive, addressable virtual content targeted to audiences or devices, potentially interactive and individualized. The present invention does not require generating or distributing “virtual content” overlays or objects that are addressable and interactive in the specific manner claimed, through virtual overlay assets, addressability targeting constraints, and distribution mechanics. Even if the present invention provides interactivity, it does not rely on the reference's virtual-content creation and addressable distribution pipeline. Accordingly, the present invention does not practice the claimed addressable virtual content creation or distribution limitations.

Thus, there is still a clear need to optimize the presentation of content to the community of fan users and their varying environments, in the hopes of identifying new fans. Our novel systems and methods test and optimize content by publishing and engaging with a cohort the fan community, adjusting the content in real-time to their interests, behaviors and environment. The content generated by the content engine results from a multi-source ingestion receiving audiovisual content and metadata from many devices either individually or in combination. The use of the content provided by the content engine in the embargo hub can be in the form of video-on-demand, live-streaming video, images, photographs, audio, text, posts, messages, community forums, electronic quizzes, advertisements, websites, icons, interactive experiences, content generated by artificial intelligence, mission specific data, health data, historic data, player metrics, operational logs, or other sources, or any combination of these, or all of these, either via digital or analog such as via online websites or physical devices or any combination thereof, regardless of the brand industry, and where said content and/or presentation are relative to the actual data collected from the interaction of users in an ecosystem such as an embargo hub. The content can be delivered in a one-to-one matching of content to individual fans or groups of fans this content can be provided either on its own or concurrently with “standard” content provided to a general community. The resulting information from the embargo hub may include cohort-level fandom information, clustering, group sentiment and allows for the use of methods to predict fan behavior in real time.

### SUMMARY OF THE INVENTION

This invention provides systems and methods for optimizing the generation and delivery of marketing and non-marketing content to fans making use of an ecosystem, such as an embargo hub, for the analysis and understanding of fan behavior in terms of fan-content interaction, fan-community interaction, and their combination. The invention allows known fans to interact with content in a secured ecosystem, such as an embargo hub, via modern secure internet experiences and blockchain technology solutions and for data collection. The systems and methods make use of two cycles of learning, the first cycle draws lessons learned from the ecosystem about fandom metrics towards the discovery of new fans from the set of all possible fans to help increase market share while the second cycle draws lessons learned from the ecosystem to help improve the content that is being generated and provided back to the fans in real-time. The systems and methods result in data, data analysis, and machine learning approaches that also help understand fandom in new ways and improve the overall quality of the fan experience and community connections, trusted fan relationships, fan sentiment, brand-fan loyalty, non-fans, or any combination, or all of these in light of optimized content and fan insights. The ecosystem data can then be merged with third party data, with intent to transfer to third parties with trust through a secure data gateway. In certain embodiments, the systems and methods further include determining cognitive, behavioral, physiological, or health-related effects associated with fan interaction with content, based on interaction data captured within the marketing ecosystem.

In one aspect, the present invention provides systems and methods to provide content in an optimized manner to a cohort of fans, comprising: a marketing ecosystem including an embargo hub for the collection and storage of data about fan dynamics and content interaction, wherein knowledge of that interaction can be used to drive decisions regarding content adjustment, and the ability to identify new fans that are likely to respond well to that content. These same systems and methods can collect data about fans who convert into non-fans through their lack of interaction or negative interaction with embargo hub content, and thereby also avoid or reduce marketing or production, or any combination of these, inefficiency.

Today, dynamic digital marketing typically mixes and matches demand (advertisers seeking targeted ad placements) with supply (publishers, platforms, and networks offering ad space) by using real-time data and algorithms. These platforms automate the buying and selling process, allowing advertisers to bid on ad slots based on viewer profiles, behavior, and context, optimizing reach and engagement for specific audiences. Often marketing content is inefficiently published with limited relevance and to both customers and non-customers alike. However, they fail to prioritize fans, fan communities, and fandom metrics through an embargo hub fan ecosystem when determining content optimization, environmental impact, and commercial economics. In another aspect, the ecosystem can be used to valuate the media value of a fan community, or sponsorship, or associated marketing, or combinations or all of these, to a fan, fan community, adjacent fandoms or collaborative communities, or a combination or all of these, to help understand the dynamic value and environmental impact of the advertising space around specific content or branded content. This presents a novel way to assist with sponsorship valuation.

In another aspect, the cohort of fans could be determined in advance or be determined through the process of the embargo hub such that fans could be identified as “known” for purposes of marketing, closed-network authentication, and invited to join the embargo hub. Alternatively, for purposes of comparison it may be important to specifically invite fans that are ambivalent to the product or service as a control group, or it might even be important to invite fans that are known to be opposed to the product or service to determine the effectiveness of that marketing.

In another aspect, the present invention provides methods of modelling both content generation, limited access and distribution to provide unique content to select fans, fandom, and fanness in new ways to help understand their correlation and improve upon marketing or content production, or their combination, rapidly over time. Unlike conventional content creation and digital marketing systems that rely on limited focus groups, static audience segmentation, post-engagement metrics, or single human directors, the invention enables real-time scoring of individuals, including fans and non-fans, as well as fan clusters and fan communities, across digital and physical environments. Fan scores may change over time as fandom levels and associated behaviors evolve and are updated dynamically in response to interaction and non-interaction with content. These inferred and continuously updated scores are used to guide the creation, optimization, assembly, and matching of content through one or directors operating under mission rules and environmental constraints.

And lastly, in another aspect, the present invention helps provide a broad and novel understanding of fans, fandom, and fanness including what it means to be a fan in a community of fans, levels or classes of fans, dynamics of fanness, transitions of fans in and out of fan communities and the reasons associated with those transitions, and what it is to not be a fan of a product, goods, services, or content or combination of the above or all of the above or other things and why.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 depicts a block diagram of the system, methods, and device for providing customized marketing content to fans while optimizing the selection of the content and fans in a dynamic manner.

### REFERENCE NUMERALS IN DRAWINGS

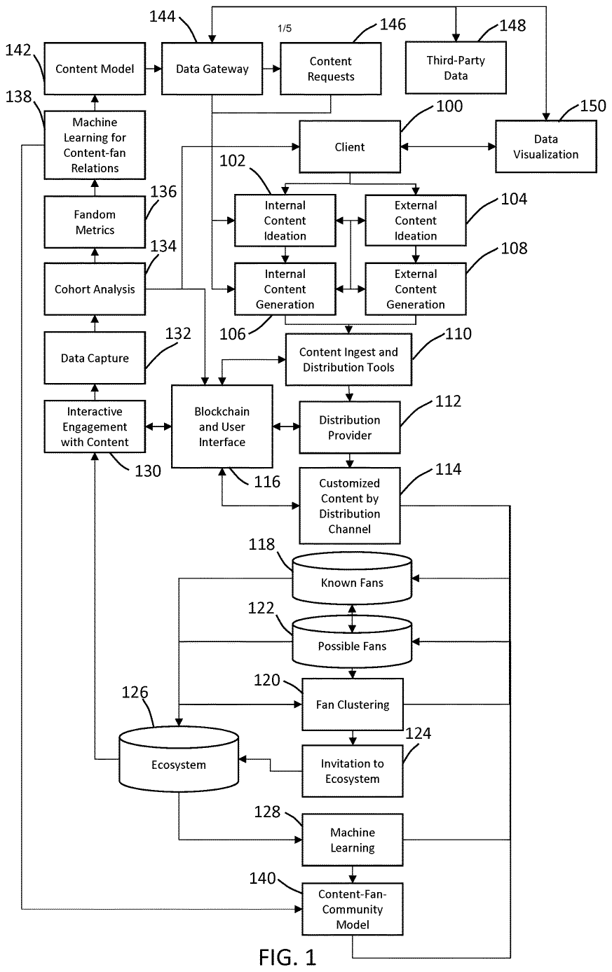

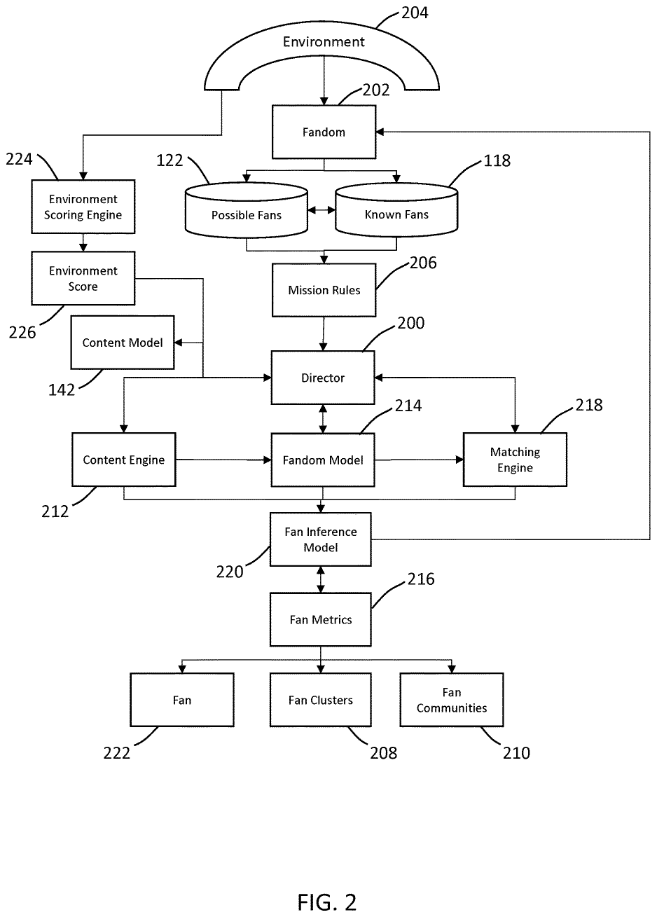

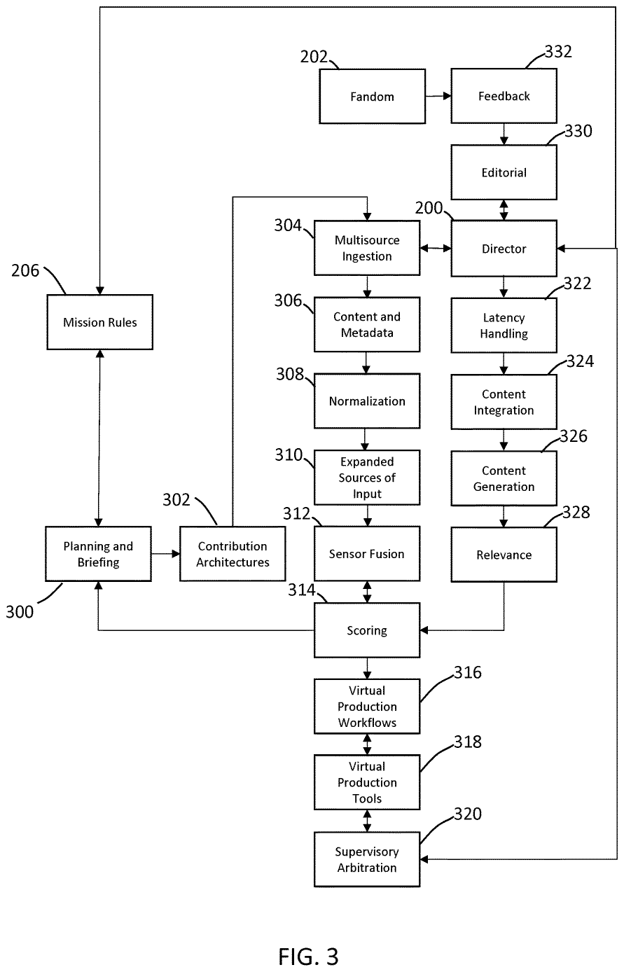

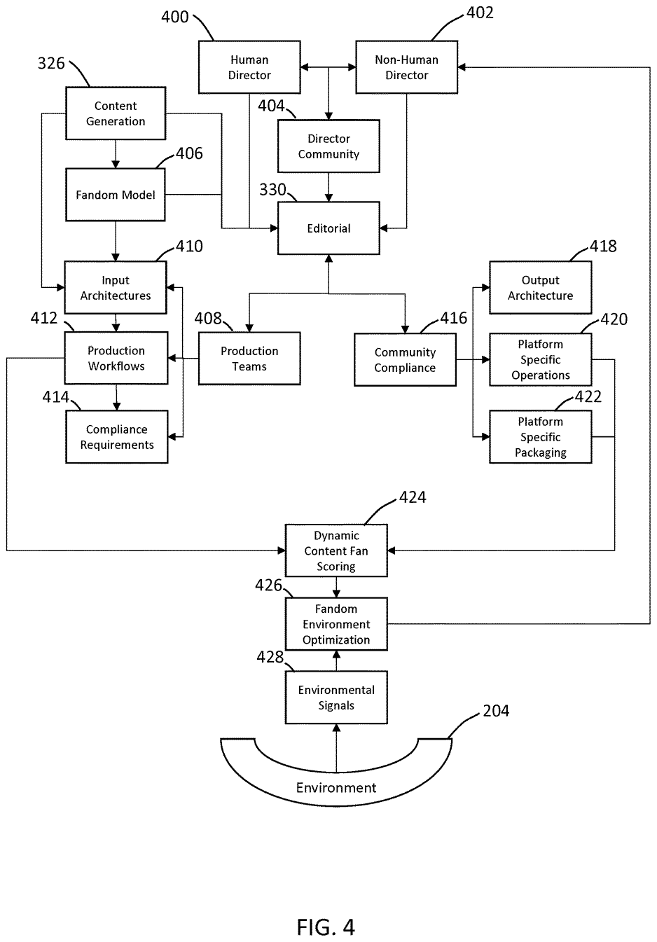

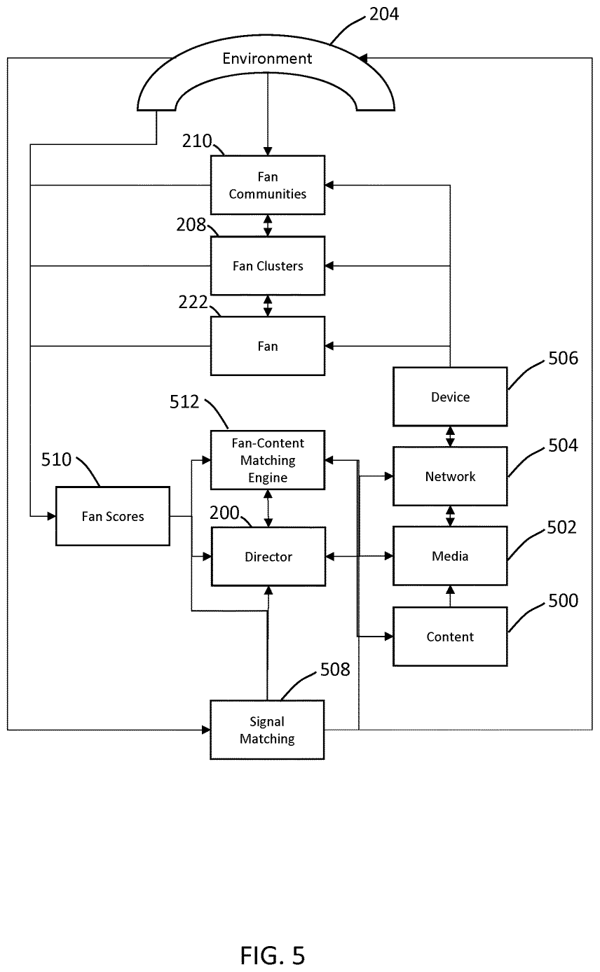

### Reference Numerals in FIG. 1

100 Client
102 Internal content ideation
104 External content ideation
106 Internal content generation
108 External content generation
110 Content ingest and distribution tools
112 Distribution provider
114 Customized content by distribution channel
116 Blockchain and user interface
118 Known fans
120 Fan clustering
122 Possible fans
124 Invitation to ecosystem
126 Ecosystem
128 Machine learning
130 Interactive engagement with content
132 Data capture
134 Cohort analysis
136 Fandom metrics
138 Machine learning for content-fan relations
140 Content-fan-community model
142 Content model
144 Data gateway
146 Content requests
148 Third-party data
150 Data visualization

### Reference Numerals in FIG. 2:

118 Known fans
122 Possible fans
142 Content model
200 Director
202 Fandom
204 Environment
206 Mission rules
208 Fan clusters
210 Fan communities
212 Content engine
214 Fandom model
216 Fan metrics
218 Matching engine
220 Fan inference model
222 Fan
224 Environment scoring engine
226 Environment score

### Reference Numerals in FIG. 3

200 Director
202 Fandom
206 Mission rules
300 Planning and briefing
302 Contribution architectures
304 Multisource ingestion
306 Content and metadata
308 Normalization
310 Expanded sources of input
312 Sensor fusion
314 Scoring
316 Virtual production workflows
318 Virtual production tools
320 Supervisory arbitration
322 Latency handling
324 Content integration
326 Content generation
328 Relevance
330 Editorial
328 Feedback

### Reference Numerals in FIG. 4

204 Environment
326 Content generation
330 Editorial
400 Human director
402 Non-human director
404 Director community
406 Fandom model
408 Production teams
410 Input architectures
412 Production workflows
414 Compliance requirements
416 Community compliance
418 Output architecture
420 Platform specific operations
422 Platform specific packaging
424 Dynamic fan content scoring
426 Fandom environment optimization
428 Environmental signals

### Reference Numerals in FIG. 5

200 Director
204 Environment
222 Fan
208 Fan clusters
210 Fan communities
500 Content
502 Media
504 Network
506 Device
508 Signal matching
510 Fan score
512 Fan-content matching engine

### DETAILED DESCRIPTION OF THE INVENTION

### Definitions

The term “content unit” as used herein shall mean any discrete portion of content capable of being scored, matched, assembled, or distributed, including frames, segments, images, audio samples, articles, paragraphs, sentences, clauses, tokens, semantic units, or combinations thereof.
The term “director” as used herein shall mean a human, non-human, or hybrid entity configured to make content decisions. References to one or more directors include a single director, multiple directors operating independently or cooperatively, hierarchical director structures or coordinated groups of directors, including combinations of human and non-human directors.
The term “editorial” as used herein shall mean the set of rules, standards, and creative visions established with fans, fan communities, and fandoms in mind so that the content generated is assured of alignment with those entities.
The term “engine” as used herein shall mean a module or process configured to execute, apply, or orchestrate one or more models, rules, data sources, or workflows to perform a defined function, operating in real time or non-real time and may include deterministic logic, probabilistic logic, or hybrid control mechanisms.
The term “environment” as used herein shall mean the physical, digital, social, temporal, regulator, or contextual conditions or any combination thereof in which content is produced, distributed, or consumed, or any combination thereof, including but not limited to platform state, competing content density, trust characteristics, network conditions, timing, access constraints, or moderation rules.

The term “environment score” as used herein shall mean a computed measure representing the suitability of an environment for content production, assembly, delivery, or distribution, based on one or more environmental conditions, contextual factors, or signals, and which may be used independently or in combination with other metrics to influence, weight, or override content-related decisions
The term “fan” as used herein shall mean a human or non-human individual who exhibits a degree of affinity (either positive or negative) or complete ambivalence towards anything. A fan may be identified explicitly, or inferred through behavior, and quantified through scoring methods.
The term “fan community” as used herein shall mean a set of all known fans for a particular thing (i.e., event, team).
The term “fan cluster” as used herein shall mean two or more known fans within the same fan community.
The term “fan metrics” as used herein shall mean a collection of fan scores.
The term “fan score” as used herein shall mean a quantitative measure of fanness on a numerical scale from negative to positive where negative represents anti-fan behavior and positive represents true fan behavior and zero is complete ambivalence.
The term “fandom” as used herein shall mean the shared passion, cultural identity, and participation of a fan community.
The term “fanness” as used herein shall mean a qualitative measure of fan affinity ranging in degree from negative to positive with ambivalence in the middle.
The term “known fans” as used herein shall mean those individuals who have been scored for their affinity relative to any thing.
The term “matching” as used herein shall mean a process of aligning content to fan, fan clusters, fan communities, fandoms, or environments or their combination based on scores or models.
The term “mission rules” as used herein shall mean constraints, objectives, policies, or guidelines governing content production, assembly, evaluation or distribution, or any combination thereof which may be defined by content owners, communities, regulatory requirements or operational goals.
The term “model” as used herein shall mean a computational, statistical, logical, or inferential representation used to analyze data, generate predictions, infer attributes, compute scores, or represent relationships, and may include without limitation, machine learning, artificial intelligence, neural networks, probabilistic approaches, rules-based logic, heuristics, or combinations thereof and be trained, updated, or adjusted dynamically or be static.
The term “possible fans” as used herein shall mean those individuals who have yet to be scored for their affinity to any thing.
The term “virtual production team” as used herein shall mean one or more automated, AI based, or computational agents configured to perform production related functions including content selection, sequencing, editing, formatting, compliance, or optimization, operating independently or in coordination with human production teams.

A preferred embodiment of the present invention is illustrated in FIG. 1.

A client 100 interested in marketing the right content in the right manner to the right fan or fan community, chooses to compose appropriate content through a process of either internal content ideation 102 through an internal department, such as marketing or external content ideation 104 through an external provider. A combination of either or both of these ideation processes can be used for internal content generation 106 or external content generation 108. Content ingest and distribution tools 110 are then used by a distribution provider 112 to provide customized content by distribution channel 114 in a way that maximizes the perceived relevance of the content to the fans typically from the same fan community receiving the content in each distribution channel. These distribution processes are recorded through a blockchain and user interface 116 that tracks the content as it is delivered to which distribution channel and to which person receiving the content in a manner that is secure and/or verifiable. In a preferred embodiment, the customized content specific to the distribution channel is provided to known fans 118, including those designated by the client or associated with particular fandoms, goods, services, or activities, as well as a range of fans based on their level of engagement and their fanness, which is deemed significant for observation in a controlled setting. While it is possible to determine the set of known fans through social network or other information, the system and method provided here helps to ensure that the pool of known fans is properly sized for each distribution channel and tracks dynamically with the available content, and as fans change their behavior and interest. For a given initial set of known fans, a process of fan clustering 120 using statistical analysis, machine learning, or other clustering approaches helps to subdivide fans by their similarities, interests, characteristics, likes, dislikes, previous behavior, or other data that can help to assess fandom. These clusters help to inform on the likelihood that someone from the much larger universe of all possible fans 122 may also be identified as a known fan of the client or content being distributed. The fans or fan cluster of greatest relevance to the evaluation of content being distributed in a particular distribution channel of interest are invited to enter a marketing ecosystem 124 as a cohort. Within the ecosystem 126, unique content is provided to this cohort in an environment, such as through a secured embargo hub, where the cohort of fans are not allowed to discuss the content publicly but may comment on the content privately within the ecosystem to the provider of the content being distributed or between other members of the ecosystem. In one aspect, the present invention provides for an embargo hub as a secure, real-time variable testing environment configured to evaluate content performance, audience response and behavioral signals prior to or during broader content release. The embargo hub provides a controlled digital or hybrid environment in which content may be selectively exposed to individuals, communities or cohorts under embargo conditions. The embargo hub enables continuous, large-scale, and automated testing that is not constrained by physical location, session-based moderation, or limited participant counts. Inputs to the embargo hub may include digital interactions, behavioral signals, biometric or sensor-derived analog data, environmental signals, or inferred responses generated through passive observation, with or without explicit participant awareness. Data collected within the embargo hub is aggregated, normalized, and stored as a persistent knowledge base representing fan behavior, preferences, sensitivities, environment scores and response patterns. This knowledge base is used to generate and update one or more fan models, which are subsequently employed by content engines and matching engines to enable adaptive content optimization to fans. In alternative embodiments, an engine may utilize, invoke, or coordinate one or more models to perform scoring, matching, optimization, production or decision-making functions. Conversely, a model may be implemented within one or more engines or shared across multiple engines, without limitation. In alternative embodiments, the embargo hub may operate in real-time and continuously feeds updated data into fan model data into production, assembly and distribution systems, thereby enabling closed-loop optimization of content prior to and during public release. A process of machine learning 128 is used to review all of the content and fan interaction within the ecosystem, to help inform about characteristics that are perceived to be of value when labeling possible fans as known fans. This machine learning can be static or dynamic, in real-time or not, to help invite fans to the ecosystem or provide valuable information about what it means to be a fan for the specific distribution channel at that time relative to the content being provided. Within the ecosystem, each cohort interacts with static or dynamic content 130 with the information associated with the ecosystem under the blockchain. Processes of data capture 132 are used along with a cohort analysis 134 to provide information about fan behavior, in terms of the like or dislike of the content being provided, and even in terms of the quality of the fans themselves within the cohort and their dedication to the client and content itself. Information from the cohort analysis can be provided back to the client to help inform their decision making about their product, activity, or service, and the content being generated, helping to complete a cycle of learning about the mapping of content and fan behavior. Such analysis results in new ways to generate novel fandom metrics 136, a collection of scores about fandoms. This analysis about the fans within the ecosystem can be used as input to machine learning for content-fan relations 138 to generate new models of the interaction of fans and content resulting in a different content-fan model 140 and a content model 142. A bi-directional data gateway 144 is used to integrate and transfer the ecosystem data to third parties 148, resulting in efficient fan and community metrics data extraction and data delivery to third parties, or the inclusion of third-party data in the machine learning and content model calculations. The content model can then be used to help generate new content requests 146 for internal content generation in real time which may improve fan interest and interaction in a dynamic manner. The data resulting from this system and method can be visualized 150 and provided to a client in an interactive manner to allow for improved understanding of the dynamics of fan behavior relative to marketing material as well as metrics such as the environmental impact of the marketing.

A preferred embodiment of the present invention is illustrated in FIG. 2.

As illustrated in FIG. 2, a director 200 seeks to produce and deliver content to a fandom 202 operating within a defined environment 204 and subject to a rubric of mission rules 206 that are established by the content owner and the fan community as these two define frameworks with which the director must operate. The fandom may include fans, subtyped as either known fans 118, or possible fans 122, fan clusters 208, and fan communities 210, each of which may be associated with fanness on a spectrum ranging from +1 to −1 affinity. The fandom exists in the context of an environment containing physical, or non-physical, or a combination of physical and non-physical elements, which may include digital, social, temporal, regulatory, or other contextual factors that dynamically constrain content relevance and behavior. Known fans and possible fans can be scored for their fanness. The director seeks to convert as many possible fans to known fans as possible and typically seeks to generate fans with positive affinity for the content in light of the environment, the current fandom, the mission rules, and fan community dynamics. A director uses the content model and content engine 212 and generates content for the fandom using the systems and methods described with reference to FIG. 1. A fandom model 214 represents the current state of the fandom, including fan metrics 216, fandom metrics, community structures and inferred behavioral tendencies. A matching engine 218 evaluates the relevance of generated content relative to individual fans, fan clusters or fan communities scores by applying and then matching the score from a fan inference model 220 score. To do this, fan metrics are derived from the existing fan 222, fan cluster 208, and fan communities 210 and fed into fan inference model 220 that learns over time what fandom means to those fans and what constitutes fandom for the particular fandom and environment, updating the fandom model in real time. Based on scores generated by the model and matching engine, the director determines which content is delivered to which fans or communities, with the objective of managing fan engagement and fandom. In one or more embodiments, the system further includes an environment scoring engine 224 configured to generate an environment score representing the suitability of a distribution environment for content delivery or production. The environment score 226 computed based on one or more environmental conditions, including but not limited to temporal activity levels or other contextual factors affecting content exposure or engagement. In certain embodiments, the environment score is combined with, weighted against, or permitted to override a relevance score, fan score, or community affinity score when determining whether, when, where, or how content is produced, assembled, or distributed. Accordingly, content that is otherwise relevant may be delayed, advanced, suppressed, amplified, rerouted through alternative trusted sources, or modified based on environmental suitability. The fan inference model can be used to affect the fandom model used by the director in real time to evaluate content in light of the fans, their mission rules, and environmental context. The director can use the matching engine to evaluate the content relative to specific fans, fan clusters, or larger fan communities to determine how well the content matches with their interest. A process of optimization within the content engine improves the content and its engagement over time through this process with the appropriate content provided to the right fan, fan cluster, or fan community at the right time and format.

A preferred embodiment of the internal operation of the content engine is illustrated in FIG. 3.

The mission rules 206 are a key component of the content engine as they inform the type of content that should be generated for a specific fandom. Mission rules inform a strategic planning and briefing 300 process that guides content ideation, asset gathering and the selection of contribution architectures 302. Assets may include audiovisual or written content, metadata, and expanded sources of input relevant to the fandom and campaign objectives. In certain embodiments, the system operates as a facilitator or intermediary that augments existing content pipelines, platforms, or communities without replacing or controlling such systems. The system functions as an enabling layer that feeds, guides, or enhances content flows into one or more downstream platforms, communities, or distribution environments based on scoring, matching, and optimization logic. The mission rules are a reflection of both the fandom 202 and the director 200 and act as the basis of a content campaign. The result of the planning and briefing leads to a set of contribution architectures that are suitable for the campaign and the fan, fan clusters, or fan communities being marketed. The director interprets the mission rules as a framework for editorial control. A process of multisource ingestion 304 captures information about fans, fan clusters, or fan communities in light of the content campaign being produced. This includes audiovisual or written content and metadata 306 information. A process of normalization 308 is used to enable interoperability across heterogeneous data sources. Such normalization can be used to perform timestamp alignment or alignment of metadata and time from differing networks or sources and normalize these relative to the mission rules and fan, fan community, or fandom model. Expanded sources of input 310 can be considered to capture sufficient information about the content and its relevance to fans in light of the mission rules and director. Sensor fusion 312 combines these normalized inputs to generate real-time or near-real-time relevance scoring 314 indicating how well content aligns with fan interests and mission objectives. This can be done in real-time, dynamically, relative to information about the content and how the content changes with time and information about the fandom and how the fandom changes with time. The real-time scoring is fed back to planning and briefing to affect change in the mission rules that could elicit specific fan behavior such as an increase in the scores associated with known fans, or an increase in the number of possible fans being engaged with, converted into known fans, or a decrease in the number of anti-fans, or other measures, or combinations of measures. Real-time scoring is also sent to a model of fan behavior as follows. Scoring data is also provided to a fan model incorporating virtual production workflows 316 and virtual production tools 318, subject to supervisory arbitration 320 where appropriate to ensure compliance with legal or mission requirements. Latency handling 322, content integration 324, and content generation 326 processes allow new or modified content to be introduced dynamically, with relevance 328 continuously evaluated and updated via the multisource ingestion which can also be fed to a director for the purpose of developing an editorial 330 using feedback 332 from a fandom. Feedback is provided by the end users evaluating the content, whether they be fans, fan communities, or fandoms.

A preferred embodiment of production and environmental optimization is illustrated in FIG. 4.

Directors in charge of production can have many forms. FIG. 4 illustrates a production framework in which content decisions may be made by a human director 400, a non-human director 402, such as an autonomous director run by artificial intelligence, or a director community 404 comprising of completely human or completely non-human, or any combination of human and non-human. For instance, a single human director could have a set of non-human computational directors assisting with production as a director community. The director or director community generates editorial 330 guidance regarding content suitability relative to the fandom model 406, mission rules, and environment. The director or director group is responsible on a one-to-one and one-to-many basis for the content, the content generation 326 in terms of its likely suitability for the fan, fan cluster, or fan community in light of that fandom's mission rules and environment. Editorial guidance is provided to virtual production teams 408, which define input architectures 410, production workflows 412 and compliance requirements 414. Community compliance 416 analysis ensures that content conforms to fandom norms, platform and network requirements, and mission constraints. This process of compliance helps define the proper output architecture 418, platform specific operations 420, and platform specific packaging 422 that may be required to reach a fan, fan cluster, or fan community. Taken together, processes 416, 418, 420 and 422 represent what is commonly known as media. The information from the production team and community compliance processes is used for dynamic content fan scoring 424 in a dynamic real-time manner. This adjusted content is then fed immediately to a process of fandom environment optimization 426 which is in turn fed to the director community for autonomous adjustment of content generation and delivery. The process of dynamic content scoring is dynamic in real time, potentially at a frame-by-frame level or at any other time granularity, based on fan response and fan environmental signals 428 representing the environment 204 at the time.

A preferred embodiment of the fan continuous optimization loop is illustrated in FIG. 5.

FIG. 5 illustrates an overarching and critical feedback loop between fans, content and the director. Content 500 is delivered through media 502 which may include encoded and packaged content to fan 222 fan clusters 208, or fan communities 210 via a network 504 and one or more device 506. Signal matching 508 associates the content from a content engine with specific fans or communities based on their assigned fan score and matching it with fan optimized content through fan relevance and context and environment. The signal matching can via a heuristic or treated as an optimization problem. The fan, fan cluster, or fan community, relative to the dynamics of their associated environment 204 can be modeled through a feedback loop. Fan interactions generate data and fan scores 510 representing fan content quality, relevance and an attribution of change in behavior relative to the content. The information regarding the fan scores is provided in real-time back to a fan-content matching engine 512 that conveys the scores and current content back to the director 200 either directly or through the network 504. These scores are transmitted in real time to a matching engine and through the network back to the director. The matching engine may update scoring parameters, and the director may adjust content, delivery, or strategy in response to observed fan behavior. In some embodiments, fans may directly score content using a device, enabling rapid system-level adaptation without direct director intervention. This continuous feedback loop allows the system to dynamically align content with fan behavior as both evolve within the environment. In certain embodiments, the data captured from fan interactions within the feedback loop may include or be used to derive cognitive, behavioral, physiological, or health-related indicators associated with exposure to content. Such indicators may be computed from interaction patterns, response latency, biometric signals, device-derived data, or other observed or inferred signals, and may be incorporated into fan scores or fandom metrics to evaluate the impact of content on individual fans or fan communities

In certain embodiments, fan scores 510 may generate other metrics based on interaction data captured from each device 506 and activity on a network 504. Such other metrics may include cognitive response indicators, behavioral response indicators, or physiological or health-related indicators associated with exposure to content. These metrics may be computed using, but not limited to; interaction frequency, engagement patterns, response latency, sentiment analysis, biometric inputs from devices, or other signals. Such data and metrics may be used to determine whether particular content produces beneficial, neutral, or harmful effects on individual fans, fan clusters or fan communities.

It is to be expected that the description of the preferred embodiment is not a limitation on variations or extensions of the invention. For example, there may be many ways to measure fan quality within an ecosystem, such as an embargo hub, and in fact the embargo hub itself can become a resource for the analysis of fan behavior and novel fandom metrics. The embargo hub can also be used to help launch and develop content, products, services, advertising or their combination, by communicating content in a manner that is targeted to a cohort of fans securely in a closed marketing ecosystem. This approach also has the benefit of fan targeting, improved fan content and community relationships, building fan advocacy and fan community for a brand and/or product, giving a special opportunity to view content before other consumers or possible fans. In addition, aspects of the blockchain could include tokenization with or without reward for specific content behaviors.

While our preferred embodiment focuses on a broad view of fan-content interaction and fan-community interaction, those trained in the art of content delivery recognize that our approach could also be either fan-content interaction only or fan-community interaction only. However, our preferred embodiment utilizes both for improved marketing content and delivery over time.

This invention described here is useful for optimizing marketing content to recipients of that content based on the content, distribution channel and engagement and information about the fan and their environment through fan score matching an interactivity. The invention combines information about brands, fans, the fan communities and information about content through a private or public, secured or unsecured, ecosystem in the form of an embargo hub that is either digital, analog, or a combination of digital and analog. The system and method can be used to drive new content generation, mission objectives, and media valuation to the right fans at the right time in a dynamic manner and allow for the understanding and identification of new likely fans from the far larger pool of possible fans. While in the preferred embodiment such content is digital, the same approach could also be used to provide analog content or combination of digital and analog content to consumers. While the preferred embodiment addresses content to fans associated with marketing of digital content, such fans or fandoms are of broad scope including already established brands or fandoms such as fans of creative material such as brands such as Apple, Tesla, and Netflix, but also Walmart and Amazon, universities, sports teams, musicians and other entertainment, gaming communities, but also can include any large group of people who feel similar engagement with a brand as in politics or religion. For instance, in the pharmaceutical industry, such engagement could take the form of users who have choices for specific medicines where the embargo hub represents a way to optimize marketing content to such user communities, develop them as fans of the medicine or company producing such medicines, and then market content to help improve market share of a larger community of individuals who would benefit from use of the medicines. Data from the embargo hub helps inform the pharmaceutical company about remote users, their demographics, trends, or other medical issues, assisting with future clinical development or clinical trial design or identification of additional medical indications. Data from the embargo hub can also help inform the pharmaceutical company about which fans are most likely to no longer be fans and hop to a competitor medicine if marketed incorrectly. The invention provides a comprehensive system and method for the autonomous individualized audiovisual production using multi-source inputs, sensor fusion, frame-level scoring at speeds that are beyond human capabilities, providing the opportunity for virtual directors to send optimized content on a dynamic basis to individual users via dynamic distribution.

It will be appreciated that details of the foregoing embodiments, given for purposes of illustration, are not to be construed as limiting the scope of this invention. Although several embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention, which is defined in the following claims and all equivalents thereto. Further, it is recognized that many embodiments may be conceived that do not achieve all of the advantages of some embodiments, particularly of the preferred embodiments, yet the absence of a particular advantage shall not be construed to necessarily mean that such an embodiment is outside the scope of the present invention.

While audiovisual content represents a preferred embodiment, the system and method described herein may be applied across any form of communication, including visual, audiovisual, audio-only, written, or other means of conveying information. In embodiments involving written or textual media, the scoring and assembly logic may operate on content units. In such embodiments, content may be scored and assembled on an article-by-article, paragraph-by-paragraph, sentence-by-sentence or multi-level basis using the same scoring, matching and optimization principles described for audiovisual content. The assembly of content may over any time horizon from real-time to non-real time. The systems and methods described herein may be implemented independently of any blockchain, distributed ledger, or token-based infrastructure, and may instead operate using conventional databases, cloud services, on-premises systems, or hybrid computing architectures.

1. A system for the improved understanding and use of fans, fandom, and fanness, the system comprising: a secured marketing ecosystem and data storage system for storing information about content, fans, and their behavior, wherein internally or externally derived content is distributed to fans of any chosen degree of fanness; wherein fans are clustered based on their fandom relative to the associated content and brand; wherein specific fans of a known fan community and/or fandom are invited to the secured marketing ecosystem to engage with content, with data captured about the fan cohorts, content, and their interaction and non-interaction; further wherein fandom metrics are quantified and dynamically updated based on such captured data; and wherein the quantified fandom metrics are used to inform, including dynamic matching of content to at least one selected from the group consisting of individual fans, fan clusters, fan communities, content modeling, content generation, assembly, content timing, distribution, fan community size, fan behavior, fan clustering, fandom, and fanness.

2. A method for the improved understanding and use of fans, fandom, and fanness, the method comprising: providing internal or external content through distribution tools, providers, and channels via a secured platform consisting of a marketing ecosystem wherein content is provided interactively to fans of any chosen degree of fanness, wherein data is captured about the interaction and non-interaction of fans and content within the marketing ecosystem, identifying and clustering fans and possible fans on a spectrum of fandom from least to most relative to brand and content; quantifying metrics about fans, fan communities, and fandoms based on the captured data; dynamically updating the quantified metrics over time; and using information from the marketing ecosystem to identify new likely fans, invite fans to the ecosystem, and provide appropriate content to the new likely fans based upon the quantified metrics, wherein the fan and content interaction informs at least one selected from the group consisting of content modeling, content generation or assembly, content timing, distribution decisions, and evolution of fan community dynamics for the improved understanding of fandom and its trajectory.

3. A system for dynamic content assembly, production, and deployment based on fandom metrics, the system comprising: a multi-source ingestion layer configured to receive content inputs from live, recorded, distributed, or swarm-based sources; a scoring component configured to evaluate the dynamic content relative to the fandom metrics; an environment evaluation component configured to assess contextual or environmental conditions affecting distribution; a matching component configured to match the dynamic content to individual fans, fan clusters, or fan communities; and a feedback mechanism configured to update the fandom metrics and content models in real time.

4. The system of claim 1, wherein the marketing ecosystem can be analog or digital or a combination of analog and digital, wherein content comprises audiovisual content, non-audiovisual content, textual content, semantic units, or combinations thereof.

5. The system of claim 1, wherein the set of fans of the known fan community or fandom or combination of known fan community and fandom are used to initialize an embargo hub within the marketing ecosystem to engage with content and wherein approaches of fan clustering or other fan metrics are used to identify possible fans that can also be invited to the ecosystem as a cohort if so desired.

6. The system of claim 1, wherein processes of machine learning, artificial intelligence, statistical inference or their combination are used to learn about fans, their fan community, their interaction, their clustering, and behavior within the marketing ecosystem resulting in a content-fan community model that can be used to predict the success or failure of content to fans of different types over time and be used to identify possible new fans for specific content and be used to adjust new content ideation or generation in the form of a content model.

7. The system of claim 1, wherein the content model is used to help inform content ideation, content generation and the fandom model or combination of content ideation, generation and the fandom model, in light of a request for content that could be used for content production; wherein data from the marketing ecosystem is provided to artificial intelligence methods for content generation to drive fan growth and community activation.

8. The system of claim 1, wherein the data captured about fan cohorts, content, and their interaction and non-interaction are used for cohort analysis to understand and improve metrics about fans, their quality, their dynamics, and relation to content, and wherein dynamically updated metrics about fans, fan communities, and fandoms are further used to determine transitions of fans between non-fan, possible fan, and known fan states, and wherein such metrics and state transitions may be made to improve the understanding of fan communities and associated products or services.

9. The system of claim 1, wherein the marketing ecosystem includes a controlled access environment configured for closed content testing and feedback collection, and wherein ecosystem-derived data support dual learning cycles including a first learning cycle for identifying new fans from possible fans based on fandom metrics and a second learning cycle for refining content generation or deployment in real time.

10. The method of claim 2, wherein the spectrums of fandom or fanness can be quantified and understood over time relative to static or dynamic content provided through an embargo hub.

11. The method of claim 2, wherein the identifying and clustering of fans makes use of statistical analysis, machine learning, or combination of statistics and machine learning.

12. The method of claim 11, wherein machine learning includes a combination of neural networks, deep learning, generative models, language models, evolutionary algorithms, reinforcement learning, support vector machines, random forest methods, swarm optimization and fuzzy logic.

13. The method of claim 2, wherein the improved understanding of fandom takes the form of quantitative measures, qualitative measures, or a combination of quantitative and qualitative measures; wherein data from the marketing ecosystem is provided to artificial intelligence methods for content generation.

14. The method of claim 2, wherein the fan user and marketing data from the ecosystem, and provided to the ecosystem, is provided via third-party systems and methods using a bi-directional data gateway to inform decision making.

15. The method of claim 2, wherein fan users may be human, other biological entities, representations of humans or biological entities, or completely autonomous, intelligent, non-biological forms.

16. The system of claim 3, wherein the environment evaluation component generates an environment score that is combined with or permitted to override fandom metrics in determining content distribution.

17. The system of claim 3, wherein content is evaluated on a frame-by-frame basis or at any set of frames up to the set of all frames considered as one image.

18. The system of claim 3, wherein content production or deployment decisions are guided by mission rules; wherein mission-specific data including geospatial data, telemetry, environmental data, health indicators, or operational signals influence scoring or production decisions.

19. The system of claim 3, wherein multiple virtual, human, and virtual and human production agents cooperate to assemble or deploy content.

20. The system of claims 1, wherein fandom metrics on their own or in combination with other metrics are used to assess cognitive, behavioral, physiological, or health-related impacts associated with human-generated, algorithmically-generated or artificial intelligence-generated content.
